(19) United States
(12) Patent Application Publication
(10) Pub. No.: US 2020/0041971 A1
(43) Pub. Date: Feb. 6, 2020

(54) SYSTEMS, METHODS, AND APPARATUSES FOR REAL-TIME HYRDRAULIC INFRASTRUCTURE STATUS AND OPERATION USING LOGICAL PIPE REPRESENTATION

(71) Applicant: Baseline, Inc., Boise, ID (US)

(72) Inventors: Benjamin Eugene Shewmake, Boise, ID (US); Tige H. Fiedor, Meridian, ID (US); Joey Aaron Wallace, Meridian, ID (US)

(21) Appl. No.: 16/533,544

(22) Filed: Aug. 6, 2019

Related U.S. Application Data
(60) Provisional application No. 62/715,173, filed on Aug. 6, 2018.

(51) Int. Cl. G05B 19/042; G05B 19/12; A01G 25/16; F15B 19/00

(52) U.S. Cl. CPC G05B 19/0425; G05B 19/12; G05B 2219/2625; F15B 19/005; A01G 25/16

(57) ABSTRACT

A real-time hydraulic representation system may comprise a memory to store information on components of a hydraulic system. The real-time hydraulic representation system may receive a component data comprising a hydraulic component type, and upstream data and downstream data associated with the component data. The real-time hydraulic representation system may generate a node comprising the component data, the upstream data, and the downstream data. Additionally, the real-time hydraulic representation system may generate a diagram illustrating the node in relation to a plurality of other nodes based on the component data, the upstream data, and the downstream data.

### RELATED APPLICATION

This application claims the benefit under 35 U.S.C. § 119(e) of U.S. Provisional Application No. 62/715,173 filed Aug. 6, 2018, which is hereby incorporated by reference herein in its entirety.

### TECHNICAL FIELD

The present disclosure relates to hydraulic systems, and more particularly to systems, methods, and apparatuses for graphically representing hydraulic infrastructure in real-time.

### BRIEF DESCRIPTION OF THE DRAWINGS

Non-limiting and non-exhaustive embodiments of the disclosure are described herein, including various embodiments of the disclosure with reference to the figures listed below.

FIG. 1 is a hydraulic structure diagram representation of a hydraulic system, according to one embodiment.

FIG. 2 is a graphical depiction of a node from the hydraulic structure diagram of FIG. 1, showing parameters of a component of a hydraulic system, according to one embodiment.

FIG. 3 is a graphical depiction of a listing of connections in a hydraulic system, according to one embodiment.

FIG. 4 is a graphical depiction of a detailed user interface showing parameters of a node from a hydraulic structure diagram representation of a hydraulic system, according to one embodiment.

FIG. 5 is an illustration of the detailed user interface of FIG. 4 disposed adjacent to a portion of the hydraulic structure diagram of FIG. 1, according to one embodiment.

FIG. 6 is an illustration of a detailed user interface disposed adjacent to a portion of the hydraulic structure diagram of FIG. 1, where the detailed user interface indicates an error within a component of a hydraulic system, according to one embodiment.

FIG. 7 is a method for positioning a node of a hydraulic structure diagram near a graphical depiction of a detailed user interface showing parameters of the node, according to one embodiment.

FIG. 8 is an illustration of a networking diagram, according to one embodiment.

FIG. 9A is a user interface with input capabilities for selecting a parent water source component when coupling a control point component to a water source component of a hydraulic structure diagram representation of a hydraulic system, according to one embodiment.

FIG. 9B is a user interface with input capabilities for selecting a child control point component when coupling a control point component to a water source component of a hydraulic structure diagram representation of a hydraulic system, according to one embodiment.

FIG. 10A is a user interface with input capabilities for selecting a parent mainline component when coupling a mainline component to another mainline component of a hydraulic structure diagram representation of a hydraulic system, according to one embodiment.

FIG. 10B is a user interface with input capabilities for selecting a child mainline component when coupling a mainline component to another mainline component of a hydraulic structure diagram representation of a hydraulic system, according to one embodiment.

FIG. 11A is a user interface with input capabilities for selecting a parent control point component when coupling a mainline component to a control point component of a hydraulic structure diagram representation of a hydraulic system, according to one embodiment.

FIG. 11B is a user interface with input capabilities for selecting a child mainline component when coupling a mainline component to a control point component of a hydraulic structure diagram representation of a hydraulic system, according to one embodiment.

FIG. 12 is a block diagram representation of a hydraulic representation system, according to one embodiment.

FIG. 13 is a method for generating a display of a hydraulic structure diagram representation of a hydraulic system, according to one embodiment.

In the following description, numerous specific details are provided for a thorough understanding of the various embodiments disclosed herein. The systems and methods disclosed herein can be practiced without one or more of the specific details, or with other methods, components, materials, etc. In addition, in some cases, well-known structures, materials, or operations may not be shown or described in detail in order to avoid obscuring aspects of the disclosure. Furthermore, the described features, structures, or characteristics may be combined in any suitable manner in one or more alternative embodiments.

### DETAILED DESCRIPTION

Hydraulic systems may be represented graphically to aid with visualization, error detection, and troubleshooting. Graphical representations of hydraulic systems may be drawn out by hand or by using software. It is possible to graphically represent a hydraulic system as a hydraulic structure diagram, where components (i.e., water sources, control points, mainlines, etc.) are represented as nodes of the hydraulic structure and pipes (i.e., water lines) are represented as lines between the nodes.

Some hydraulic systems may be significantly complex, having component identifiers of 100 or more. Manually creating a visual representation of such a large hydraulic system would require significant time and effort and be prone to introduce errors. When manually creating or modifying a complex hydraulic structure diagram of a hydraulic system, technicians and/or plumbers may introduce errors in the diagram. Further, a small change in a complex system may require significant amounts of time and effort from the technicians and/or plumbers to update the hydraulic structure diagram. For example, if a complex hydraulic structure diagram of a hydraulic system were drawn by hand and it was later decided that a new component should be added, depending on the location of the new component, it could be necessary to redraw large portions of the hydraulic structure diagram. Alternatively, if a complex hydraulic structure diagram were represented in a GUI (graphical user interface) and it was later decided that a new component should be added, the technicians and/or plumbers may be required to manually move significant portions of the hydraulic structure diagram, manually add the new component, and possibly manually insert and/or remove lines between various components.

A system to address some of the forgoing challenges by automating the task of creating or modifying a hydraulic structure diagram representation of a hydraulic system may be desirable. The disclosed embodiments include systems, methods, and apparatuses for automating tasks relating to creating and modifying hydraulic structure diagram representations of hydraulic systems, thereby potentially decreasing the likelihood of human error being introduced into such representations, and potentially reducing the amount of time required to update such representations. Specifically, embodiments of the present disclosure include means to represent a hydraulic system as a hydraulic structure diagram, where components of the hydraulic system may be represented as nodes of the hydraulic structure and pipes or other connections may be represented as lines between the nodes. Further, the system of the present disclosure includes means to add or remove a node(s) by specifying desired parent-child relationships between nodes. Once the desired parent-child relationships are provided, the system of the present disclosure may update the hydraulic structure diagram automatically such that added node(s) are represented as being coupled to the specified parent-child node(s) via lines, or such that removed node(s) are no longer represented and parent-child relationships around the previously existing node(s) are reconfigured.

Additional details and examples are provided with reference to the figures below. Generally speaking, the systems and methods disclosed herein may be adapted to interface with or be included as part of a software program for hydraulic systems.

The phrases “connected to” and “in communication with” refer to any form of interaction between two or more components, including mechanical, electrical, magnetic, and electromagnetic interaction. Two components may be connected to each other, even though they are not in direct contact with each other, and even though there may be intermediary devices between the two components.

Some of the infrastructure that can be used with embodiments disclosed herein is already available, such as: general-purpose computers, computer programming tools and techniques, digital storage media, and communications networks. A computer may include a processor, such as a microprocessor, microcontroller, logic circuitry, or the like. The processor may include a special-purpose processing device, such as an ASIC, PAL, PLA, PLD, FPGA, or other customized or programmable device. The computer may also include a computer-readable storage device, such as non-volatile memory, static RAM, dynamic RAM, ROM, CD-ROM, disk, tape, magnetic memory, optical memory, flash memory, or another computer-readable storage medium.

Suitable networks for configuration and/or use, as described herein, include any of a wide variety of network infrastructures. Specifically, a network may incorporate landlines, wireless communication, optical connections, various modulators, demodulators, small form-factor pluggable (SFP) transceivers, routers, hubs, switches, and/or other networking equipment. The network may include communications or networking software, such as software available from Novell, Microsoft, Artisoft, and other vendors, and may operate using UDP, TCP/IP, SPX, IPX, SONET, and other protocols over twisted pair, coaxial, or optical fiber cables; telephone lines; satellites; microwave relays; modulated AC power lines; physical media transfer; wireless radio links; and/or other data transmission “wires.” The network may encompass smaller networks and/or be connectable to other networks through a gateway or similar mechanism.

Aspects of certain embodiments described herein may be implemented as software modules or components. As used herein, a software module or component may include any type of computer instruction or computer-executable code located within or on a computer-readable storage medium, such as a non-transitory computer-readable medium. A software module may, for instance, comprise one or more physical or logical blocks of computer instructions, which may be organized as a routine, program, object, component, data structure, etc., that perform one or more tasks or implement particular data types, algorithms, and/or methods.

A particular software module may comprise disparate instructions stored in different locations of a computer-readable storage medium, which together implement the described functionality of the module. Indeed, a module may comprise a single instruction or many instructions, and may be distributed over several different code segments, among different programs, and across several computer-readable storage media. Some embodiments may be practiced in a distributed computing environment where tasks are performed by a remote processing device linked through a communications network. In a distributed computing environment, software modules may be located in local and/or remote computer-readable storage media. In addition, data being tied or rendered together in a database record may be resident in the same computer-readable storage medium, or across several computer-readable storage media, and may be linked together in fields of a record in a database across a network.

The embodiments of the disclosure can be understood by reference to the drawings, wherein like parts are designated by like numerals throughout. The components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments.

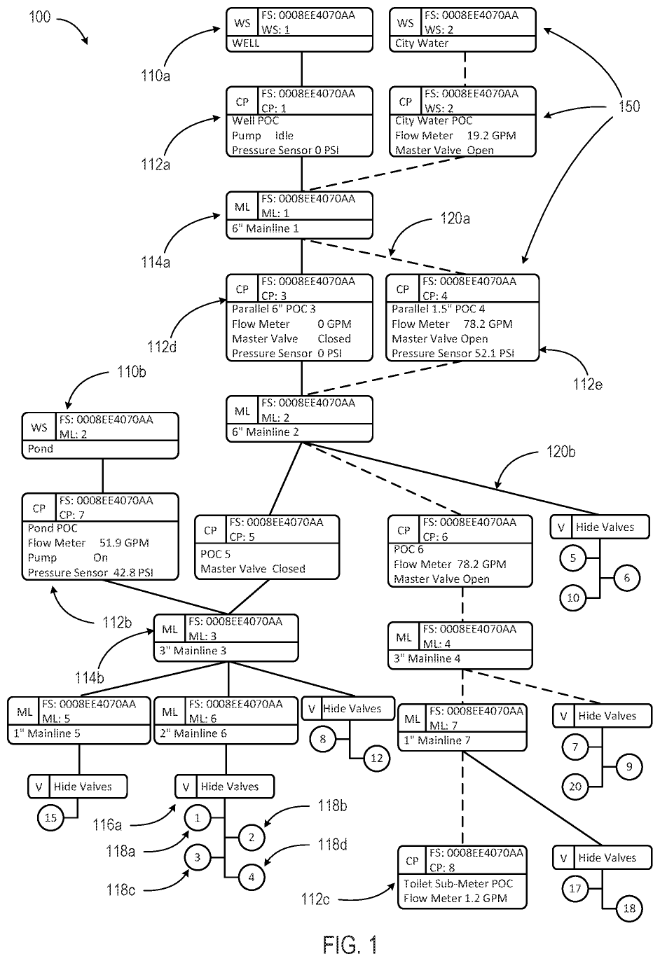

FIG. 1 is a GUI displaying a hydraulic structure diagram 100 that represents a hydraulic system. In various applications it may be desirable to represent a hydraulic system graphically.

The hydraulic structure diagram 100 of FIG. 1 may be a part of a GUI for a program for representing a hydraulic system in an automated fashion. In various embodiments, the system of the present disclosure may allow for automatic creation or modification of a hydraulic structure diagram (such as the hydraulic structure diagram 100 of FIG. 1), thereby reducing the possibility of human error and/or reducing the amount of time required to create or modify the diagram when compared with a manual hydraulic structure diagram creation and modification approach.

According to FIG. 1, the hydraulic structure diagram 100 may comprise various nodes 150 and lines 120, wherein the nodes 150 are coupled to one another via the lines 120. In one embodiment, the nodes 150 of the hydraulic structure diagram 100 may represent various components of a hydraulic system and the lines 120 may represent pipes, water lines, or other connectors. The nodes 150 of the hydraulic structure diagram 100 may represent, for example, water sources 110a 110b, control points 112a, 112b, 112c, 112d, 112e, mainlines 114a 114b, valve boxes 116a, or valves 118a, 118b, 118c, 118d.

A water source 110a, 110b may be a pond, well, city water source, or other body of water. The nodes representing the water sources 110a, 110b display information related to the water source. For example, the nodes representing the water sources 110a, 110b may display water source type (e.g., pond, well, city water), availability of the water source, and other conditions of the water source. For example, in some embodiments the hydraulic system may include one or more moisture sensors tracking water levels within a water source, and a node representing the water source may display the water availability (e.g., full, empty, percent of capacity).

A control point 112a-112e may be a device comprising means (such as a valve) for allowing or disallowing water to pass through to a subsequent component. Further, a control point may comprise means (such as a pump) for pumping water through the control point to subsequent components. The control point may be in series or parallel. For example, control point 112d and control point 112e are in parallel with each other and can be individually controlled to dynamically adjust flow to downstream components. A group of control points in parallel may allow one control point to bypass another control point. For example, water may still flow to downstream components when control point 112d is shut but control point 112e is open. Also, control points in parallel may both allow flow at the same time. Thus, the parallel control points may adjust the flow rate based on demand of the hydraulic system.

Mainlines 114a, 114b may be large pipes that may serve as junctions of smaller pipes. A valve 118a-118d may be a standard device for allowing or disallowing water to pass. A valve box 116a may be a collection of controls for valves 118a-118d.

According to the figure, lines 120 coupling nodes 150 together represent pipes coupling components of a hydraulic system together. In various embodiments, the lines 120 of the hydraulic structure diagram 100 may have a distinction to identify whether water is flowing through the pipes. In the embodiment of FIG. 1, a dotted line 120a may represent a pipe that has water flowing through, while a continuous line 120b may represent a pipe that does not have water flowing through. In some embodiments, color may be used in the GUI to represent the path of water. For example, components and pipes may be blue when water is flowing through. Further, components and pipes may be red or grey when no water is flowing through. In some embodiments, components and pipes may be blue when water is flowing through as expected, grey when no water is flowing through as expected. In some embodiments, the components and pipes may be red to show an error. For example, the components and pipes may turn red when water is flowing through unexpectedly. As another example the components and pipes may turn red when water is expected to be flowing through the components and pipes, based on valve positions, but is not.

Nodes 150 of the hydraulic structure diagram 100 may be arranged in a parent-child relationship, where a parent node 150 is upstream of a child node 150. For example, the water source 110a is the parent of the control point 112a (i.e., the control point 112a is the child of the water source 110a), and the control point 112a is the parent of the mainline 114a (i.e., the mainline 114a is the child of the control point 112a). When a hydraulic structure diagram is created or modified, the system of the present disclosure may prompt the user to input parent-child relationships and thereafter automatically generate an updated hydraulic structure diagram.

The nodes 150 of the hydraulic structure diagram 100 may display information about parameters from the components they represent. For example, the control point 112a may display the pressure reading within the control point component. The components of the hydraulic system may each include various sensors, detectors, readers, gauges, and/or other sensing mechanisms to gather component parameters and/or data (e.g., pressure, status, flow rate, etc.). Further, the components of the hydraulic system may include means for transmitting component parameters and/or data to a web client whereon a hydraulic structure diagram (such as the hydraulic structure diagram 100) may be viewed. For example, each component may be in communication with a controller, and the controller may include a transmitter to transmit the parameters of all of the components.

In some embodiments, the GUI may include filtering tool. The filtering tool allows a user to alter the view of the hydraulic structure diagram 100 based on one or more filters. The filters alter viewable nodes based on one or more criteria such as geographical location, component type, controller, company, or project. For instance, the filtering tool may receive input from a user indicating that the user desires to view a hydraulic structure diagram of a company that controls multiple sites, and the system may redraw the hydraulic structure diagram 100 to include each of the multiple sites. As another example, the filtering tool may receive input from a user indicating that the user desires to view components controlled by a controller (e.g., control points 112a, 112b, 112c), and the system may limit the viewable components to the control point representing the controller and associated downstream components.

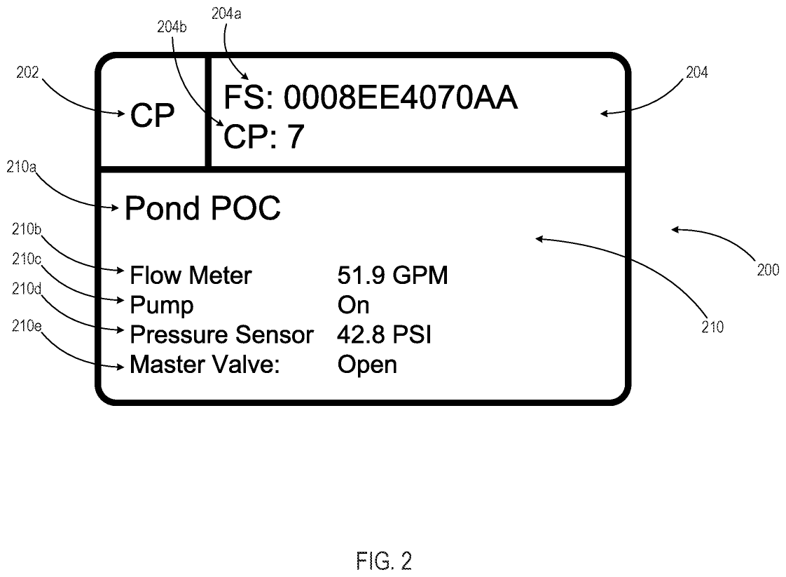

FIG. 2 is a node 200 from the hydraulic structure diagram 100 of FIG. 1. The node 200 represents a component of a hydraulic system. According to various embodiments, the node 200 may display various parameters and/or specifications of the component for which it represents.

The node 200 comprises a component specifications area 204 and a component parameters area 210. Further, the node 200 includes a component type 202 representing the type of component above the component parameters area 210 and next to the component specifications area 204. The component specifications area 204 includes a flow station identifier 204a and a component identifier 204b. In some embodiments, the flow station identifier 204a may be replaced with a controller identifier. In some embodiments, a controller identifier may be included in addition to the flow station identifier 204a. The component parameters area 210 includes a component description 210a, a flow meter reading 210b, a pump status 210c, and a pressure sensor reading 210d, and a master valve definition 210e.

The component type 202 identifies the type of component that the node 200 represents. In FIG. 2, the component type 202 displays CP because the node 200 represents a control point. If the node 200 represented a different component such as a water source, mainline, or valve box, the component type 202 would identify the type of component with a different display such as WS, ML, or V respectively. In various hydraulic systems, more than one type of component may be present, and more than one component of a single type may be present. For example, the hydraulic structure diagram 100 of FIG. 1 includes nodes 150 that represent eight control points. In FIG. 2, the component identifier 204b displays 7 because the node 200 represents the seventh control point of the hydraulic system.

The flow station identifier 204a identifies the flow station number associated with the component that the node 200 represents. In embodiments where the node displays a controller identifier, the controller identifier identifies the controller associated with the component that the node 200 represents. A flow station may be a station to send control commands to and receive data from various components of a hydraulic system. In complex hydraulic systems, more than one flow station may be required in order to control each component of the hydraulic system.

The component identifier 204b identifies the component that the node 200 represents.

The component description 210a represents the control point's description. For example, the component description 210a displays “Pond POC” because the control point component that the node 200 represents controls a pond water source.

The flow meter reading 210b displays the flow rate in gallons per minute within the component that the node 200 represents. The pump status 210c indicates whether the pump (if the component that the node 200 represents includes a pump therein) is on, off, or idle. The pressure sensor reading 210d displays the pressure value in pounds per square inch within the component that the node 200 represents. The data for the flow meter reading 210b, pump status 210c, and pressure sensor reading 210d may be acquired from one or more sensors within the component. In various applications, the flow meter reading 210b, pump status 210c, and pressure sensor reading 210d may be updated periodically (i.e., any time new data is sent from the sensors to the system displaying the node 200). The master valve definition 210e may show the state of a master valve associated with the node 200.

In one embodiment, a node may be defined in memory and/or stored as a node record in a database. For example, the node record may be a javascript object to be rendered for display when a hierarchy hydraulic structure is drawn. The node record may comprise the following data:
Parents
Children
Connectors
Component
Depth
Position

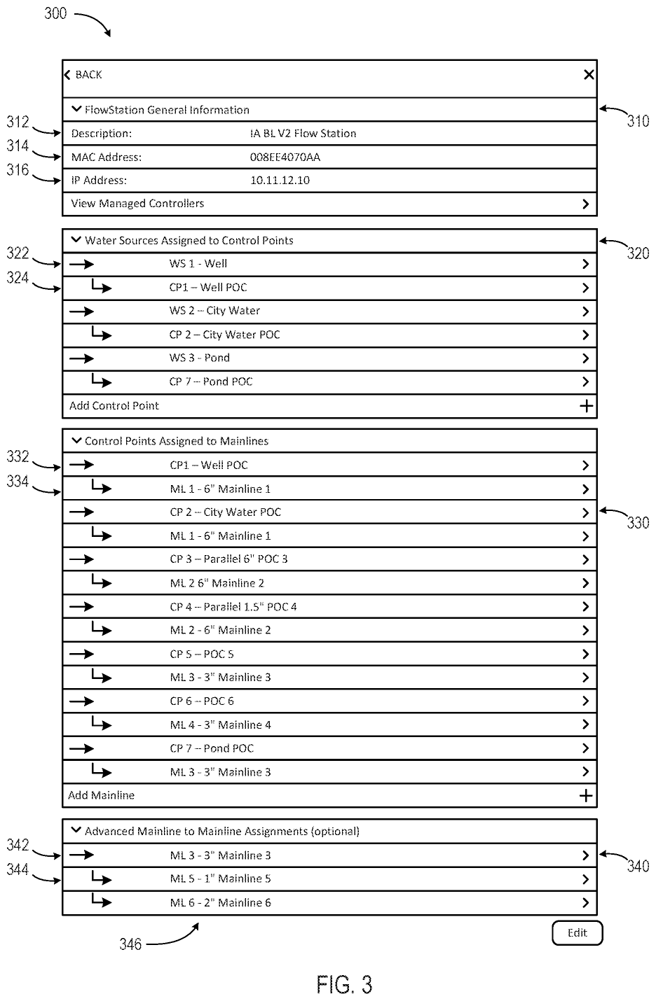

FIG. 3 is a window 300 showing information about the hydraulic system. In various applications, the window 300 of FIG. 3 may be an alternative visualization tool to the hydraulic structure diagram 100 of FIG. 1 for visualizing a hydraulic system. Specifically, the window 300 of FIG. 3 may provide listings of various connections between components of a hydraulic system.

The window 300 comprises a first sub-window 310, a second sub-window 320, a third sub-window 330, and a fourth sub-window 340. The first sub-window 310 provides general information about the flow station. For example, the first sub-window 310 includes a flow station description 312, a MAC address 314, and an IP address 316. The second sub-window 320 shows connections between water sources and control points. Specifically, the second sub-window 320 shows the parent-child relationships between various water sources and control points. For example, the second sub-window 320 includes a representation of a first water source 322 and a representation of a first control point 324, where the first control point 324 is illustrated as being a child of the first water source 322. The third sub-window 330 shows connections between control points and mainlines. Specifically, the third sub-window 330 shows the parent-child relationships between various control points and mainlines. For example, the third sub-window 330 includes a representation of a second control point 332 and a first mainline 334, where the first mainline 334 is illustrated as being a child of the second control point 332. The fourth sub-window 340 shows connections between various mainlines. Specifically, the fourth sub-window 340 shows the parent-child relationships between various mainlines. For example, the fourth sub-window 340 includes a representation of a second mainline 342, a third mainline 344, and a fourth mainline 346, where the third mainline 344 and the fourth mainline 346 are both children of the second mainline 342.

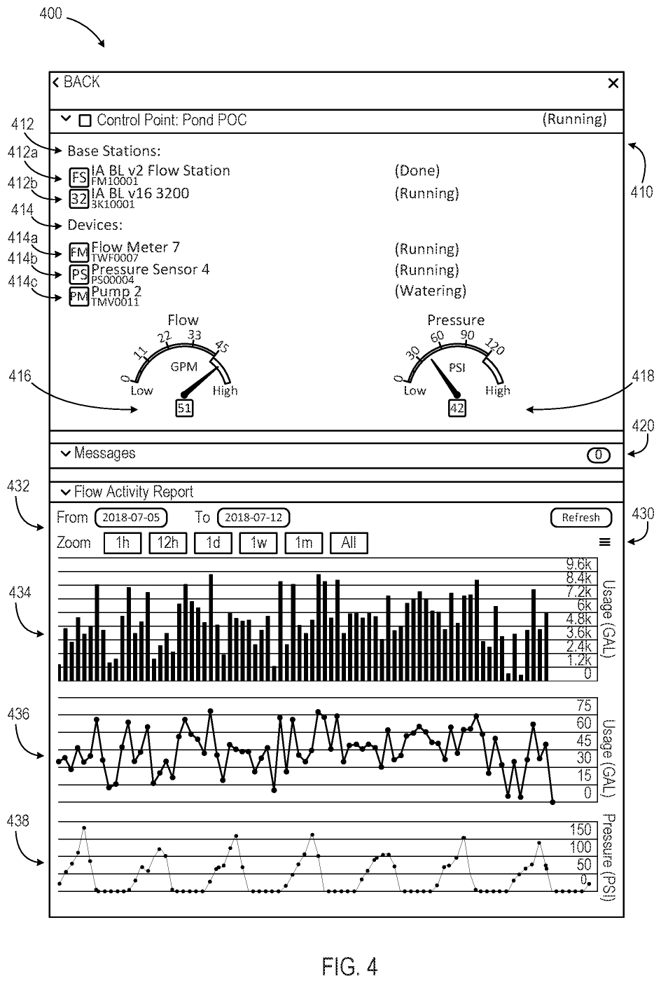

Various components represented in the window 300 of FIG. 3 may correspond to components represented in the hydraulic structure diagram 100 of FIG. 1. For example, the first water source 322 of the window 300 of FIG. 3 may correspond to the first water source 110a of the hydraulic structure diagram 100 of FIG. 1. In various embodiments, a user may be able to switch from a hydraulic structure diagram view of a hydraulic system (such as FIG. 1) to an alternative list-type view of the same hydraulic system (such as FIG. 3) by performing an action such as clicking a button to open a window or otherwise performing a manipulation of an input component of the GUI. In some embodiments, a user may click on a specific component represented in the window 300 of FIG. 3 and view the specifications and/or parameters of the component in a separate window. For example, if a user clicks on a specific component represented in the window 300 of FIG. 3, an image similar to the node 200 of FIG. 2 may be displayed, wherein information about the component may be updated in real-time. In some embodiments, if a user clicks on a specific component represented in the window 300 of FIG. 3, a window similar to the window 400 of FIG. 4 (described below) may be displayed, wherein information about the component may be updated in real-time.

FIG. 4 is a component window 400 for one of the nodes 150 of the hydraulic structure diagram 100 of FIG. 1. The component window 400 includes current information pertaining to a component of a hydraulic system. The component window 400 may be opened when a user clicks on a node 150 of the hydraulic structure diagram 100 of FIG. 1. Alternatively, the component window 400 may be opened when a user clicks on a component represented in the window 300 of FIG. 3. The information represented in the component window 400 may differ depending on which type of component the component window 400 represents. In the example of FIG. 4, the component window 400 is for a control point.

The component window 400 includes a first sub-window 410, a second sub-window 420, and a third sub-window 430. The first sub-window 410 includes base stations information 412 and devices information 414. The second sub-window 420 is for messages to the user. The third sub-window 430 includes the flow activity report.

The base stations information 412 includes a flow station identifier 412a and a second controller type 412b. In highly complex hydraulic systems, more than one flow station may be required to control various components of the hydraulic system. The flow station identifier 412a indicates the specific flow station that corresponds to the component represented in the component window 400. The second controller type 412b indicates the controller (BaseStation 3200, “32”) that corresponds to the component represented in the component window 400

The devices information 414 represents the current hydraulic devices in use for the control point and their current operational status. In the illustrated embodiment, the devices information 414 includes a flow meter sensor 414a, a pressure sensor 414b, and a pump status 414c. The flow meter sensor 414a 414a represents the assigned flow sensor for the control point with its current operational status. The pressure sensor 414b represents the assigned pressure sensor for the control point with its current operational status. According to the example of FIG. 4, the component of interest is a control point. The control point includes a flow meter for measuring the rate at which water passes through the control point, a pressure sensor for measuring the pressure within the control point, and a pump for pumping water through the control point. Each device within the control point may transmit data to the system for representing the hydraulic system, and the values for the flow meter sensor 414a, the pressure sensor 414b, and the pump status 414c (i.e., a value to represent whether the pump is engaged or not) on the component window 400 of FIG. 4 may be updated in real-time.

The first sub-window 410 also includes a second representation of some of the aforementioned parameters. Specifically, the first sub-window 410 includes a flow gauge 416 and a pressure gauge 418. A gauge representation may convey information to a user regarding how close a value is to a certain threshold, so the user can identify if the values are in a target operational range.

The messages in the second sub-window 420 may include messages to a user. A message may be generated if a problem occurs within the hydraulic system. For example, if a pump fails to turn off after a request to turn off is sent, a message may be generated in the second sub-window 420 that notifies a user of the location and details of the error.

The flow activity report of the third sub-window 430 includes a plot of water usage 434 in gallons, a plot for rate 436 in gallons per minute, and a plot for pressure 438 in PSI. The third sub-window 430 also includes an area 432 that allows a user to specify a time period for the graphs. The system of the present disclosure may store a history of sensor readings for each component for an amount of time determined by a user. The area 432 of the third sub-window 430 may allow for a user to specify a start and end date for the plots. Further, the area 432 of the third sub-window 430 may allow for a user to specify the amount of time (e.g., in weeks, months, days, hours, minutes, etc.) to plot against.

Users may define thresholds for various parameters of each component, where if a parameter passes a certain threshold, an error message may be sent, or the hydraulic system may shut off. In various embodiments, a threshold may be defined by the system of the present disclosure determining a history of the various parameters and determining an allowable variance from typical performance.

In various applications, parameter readings, gauge images, messages, and/or graphs may be sent to remote internet enabled devices such as cell phones, smart watches, and/or tablets.

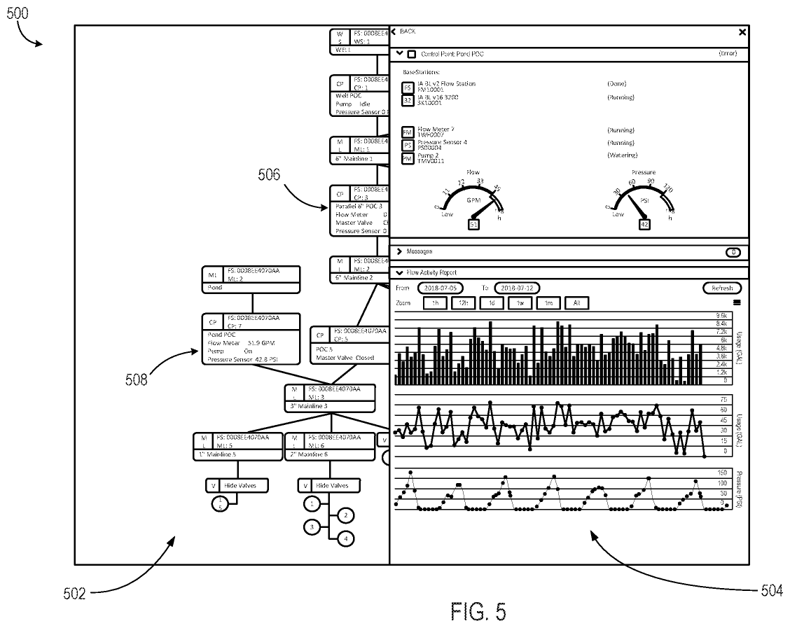

FIG. 5 is a display of a main window 500, where within the main window 500 a first window 502 is overlaid by a second window 504. The first window 502 includes a hydraulic structure diagram 506 to represent a hydraulic system (similar to the hydraulic structure diagram 100 of FIG. 1). The second window 504 is a component window (similar to the component window 400 of FIG. 4). The second window 504 corresponds to a selected node 508 from the hydraulic structure diagram 506 of the first window 502. Specifically, the selected node 508 from the hydraulic structure diagram 506 represents a component of a hydraulic system and the second window 504 provides specific details of that component of the hydraulic system.

The second window 504 may be opened when a user selects (i.e., clicks on) a node from the hydraulic structure diagram 506. When the second window 504 is opened, it may be positioned such that both the second window 504 and the selected node 508 become visible on the same main window 500. For example, according to FIG. 5, the second window 504 comes into view on the right-hand side of the main window 500 and the first window 502 is adjusted such that the selected node 508 is centered on the left-hand side of the main window 500. In other embodiments, a user may select a node that may be positioned on the right-hand side of the hydraulic structure diagram 506, and the second window 504 may come into view on the left-hand side of the main window 500 and the first window 502 may be adjusted such that the selected node 508 is centered on the right-hand side of the main window 500.

In some embodiments, a user may adjust the size of the second window 504. In such an embodiment, the first window 502 may adjust such that the selected node 508 may keep in view. Also, in some embodiments, a user may move the second window 504 relative to the main window 500. In such embodiments, the first window 502 may adjust and/or move such that the selected node 508 may keep in view. Further, in other embodiments, the main window 500 may be resized. In such embodiments, the first window 502 and the second window 504 may be centered and/or scaled as needed in order to keep the selected node 508 and the second window 504 in view. The first window 502 may be zoomed in or out, or be adjusted left, right, up, or down in order to keep the selected node 508 in view.

The selected node 508 may include a distinction from the other components of the hydraulic structure diagram 506. For example (as illustrated in FIG. 5), the selected node 508 may display a shadow around the boundaries of the selected node 508 once selected (i.e., clicked on).

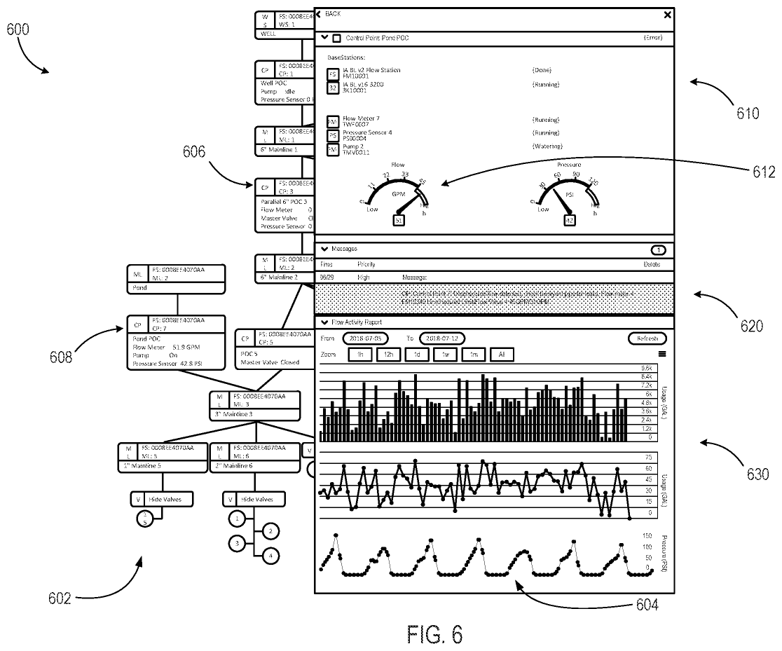

FIG. 6 is a display of a main window 600 (similar to the main window 500 of FIG. 5), where within the main window 600 a first window 602 is overlaid by a second window 604. The positioning and sizing of the windows and components of FIG. 6 are identical to the positioning and sizing of the windows and components of FIG. 5. Similar to FIG. 5, the first window 602 includes a selected node 608 from a hydraulic structure diagram 606. Also, similar to FIGS. 4 and 5, the second window 604 of FIG. 6 is a component window that comprises a first sub-window 610 for parameter readings, a second sub-window 620 for messages to the user, and a third sub-window 630 for plots. Further, the second window 604 corresponds to the selected node 608 of the first window 602.

FIG. 6 illustrates how the display may differ from that of FIG. 5 when a selected node has an error. According to FIG. 6, the selected node 608 represents a component that has an unscheduled flow. The first sub-window 610 of the second window 604 identifies the error by displaying a gauge 612 with the spindle pointing to an extreme area of the gauge 612. The second sub-window 620 identifies the error by including a message to the user, wherein the message may include details about the error (i.e., where the error is located, suggestions for repair, troubleshooting recommendations, etc.). When an error is detected in the system, the message of the second sub-window 620 may be sent out to remote internet enabled devices such as smart phones, computers, smart watches, and/or tablets to notify users and/or technicians.

Attributes such as color or shade of various components may change when a selected component has an error. For example, the selected node 608 and the second sub-window 620 may change from blue to red (or more generally from one color or shade to another color or shade) when an error is detected. One of skill in the art can appreciate that a variety of attributes or differences can be utilized or otherwise applied to various components of the system of the present disclosure when an error is detected. For example, the display of the selected component can include an animation when an error is detected. Alternatively (or in addition), the system of the present disclosure can emit a sound such as a beep or alarm when an error is detected.

An error may be identified when the reading from the sensors of the component of the hydraulic system passes a specific threshold. The error threshold may be defined by a user at any time, or it may be defined when the system of the present disclosure recognizes a significant variation from normal behavior.

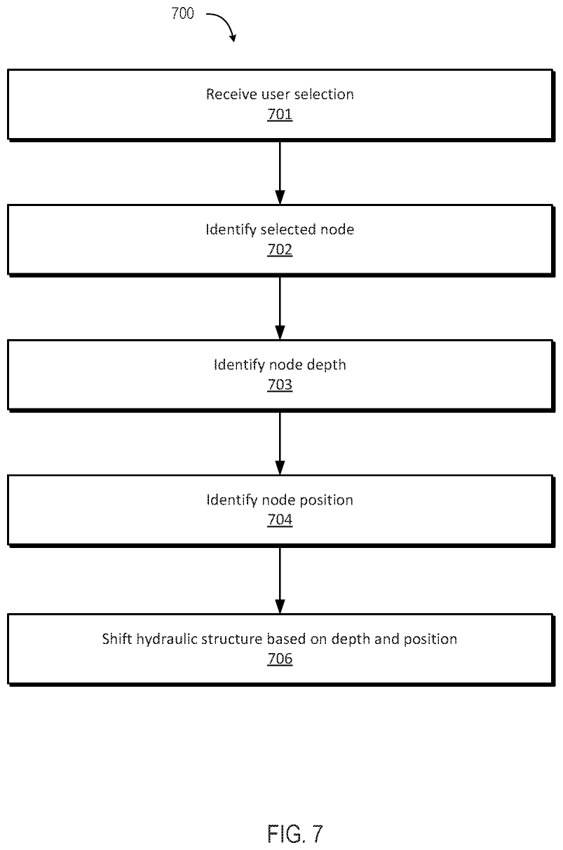

FIG. 7 is a method 700 for positioning a node of a hydraulic structure diagram near a window (such as the component window 400 of FIG. 4). In various applications, the method 700 may include ensuring that when a user selects a node to open a window (where the window displays detailed information about the node), the node remains visible to the user regardless of how the user modifies the sizing and/or positioning of the window.

The method 700 may initiate by performing the step of receiving 701 the user selection. According to various embodiments, the user(s) may select a node to view in detail by clicking on the node. The method 700 may then perform the step of identifying 702 the selected node. Once the selected node has been identified 702, the method 700 may perform the step of identifying 703 the depth of the node. The depth of the node is the number of nodes between the top of the hydraulic structure and the selected node. The method 700 may then perform the step of identifying 704 the position of the selected node. The position is the horizontal position the selected node has in the hydraulic structure relative to other nodes at the same depth in the hydraulic structure. The method 700 may then perform the step of shifting 706 the hydraulic structure diagram based on the depth and position of the selected node such that the selected node is visible with the component window open.

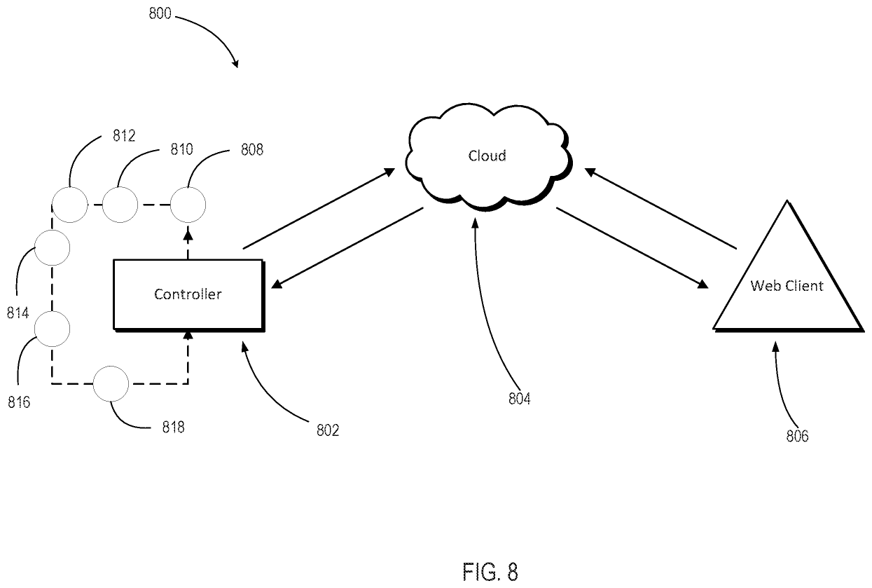

FIG. 8 is a networking diagram 800 for a hydraulic system. According to various embodiments, components of a hydraulic system may include sensors to gather data for various parameters. FIG. 8 illustrates how data from sensors of a component of a hydraulic system may reach a web client whereon the system of the present disclosure may be used and/or viewed.

The networking diagram 800 comprises a controller 802, a cloud 804, and a web client 806. The controller 802 may be a data collection center, wherein information from sensors from the various components (e.g., pump sensor, mainline valve 810, pressure sensor 812, flow meter 814, zone 1 valve 816, and zone 2 valve 818) may be stored. For example, a component of a hydraulic system may include a flow meter 814 to measure the rate at which water flows through the component, a pressure sensor 812 to measure the water pressure within the component, a pump sensor to determine the state (engaged or idle) of a pump 808 within the component, and/or a valve sensor to determine the state (open or closed) of a valve(e.g., mainline valve 810, zone 1 valve 816, and zone 2 valve 818) within the component. The information gathered by the sensors within the component may be sent to the controller 802. The controller 802 may send the information to the cloud 804.

The cloud 804 may be a remote server to receive data from the controller 802 and send data to the web client 806. The web client 806 may be an internet enabled device such as a computer, smart phone, smart watch, tablet, or other internet enabled device wherein the system of the present disclosure may be used and/or viewed.

When a user makes a change to a representation of a hydraulic system (such as to the hydraulic structure diagram 100 of FIG. 1), the system of the present disclosure may prompt the user to specify the type of change (e.g., specify whether the user wishes to rearrange nodes within the diagram, remove nodes from the diagram, or add nodes to the diagram). The system of the present disclosure may initiate the change by prompting the user to specify the parent of the selected node. Further, the system of the present disclosure may also prompt the user to specify whether the node to be attached to the previously identified parent is an existing component or a new component. In some embodiments, the change may be relayed back to the controller to allow the controller 802 to send control signals to and receive data from new components. In addition, changes in relationships may be transmitted to the controller 802 and the controller modifies a control signal to address a change in relationship. For example, if a pump is changed, the controller 802 may update the communication protocol. In another example, if the valve's relationship to a water source is changed, the controller 802 may alter the on and off control signal to properly route water to a scheduled zone.

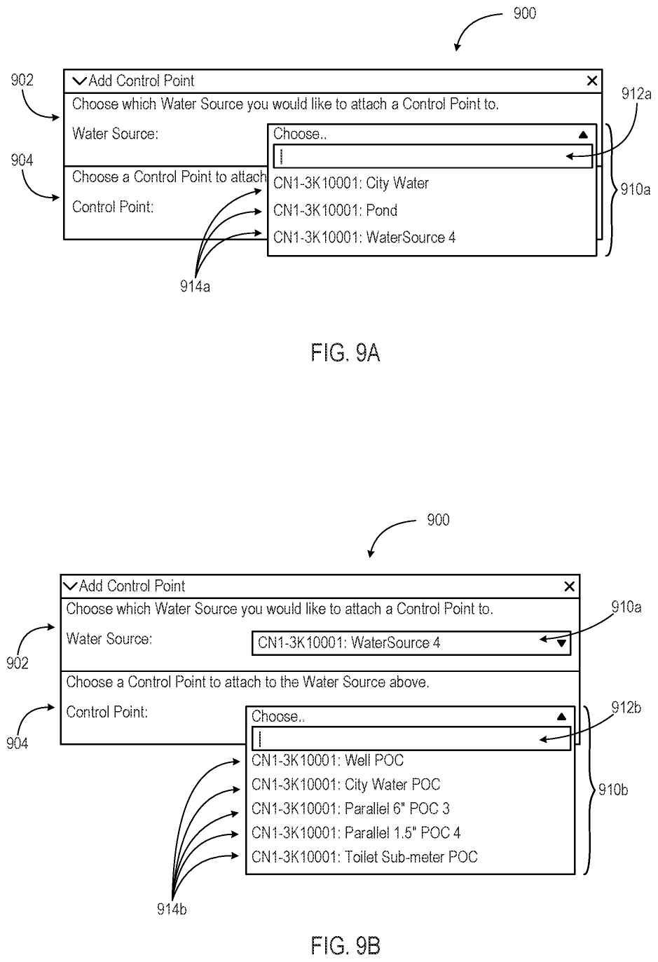

FIGS. 9A and 9B illustrate a window 900 for adding a new or changing the arrangement of an existing control point to a representation of a hydraulic system (such as to the hydraulic structure diagram 100 of FIG. 1). FIG. 9A illustrates how a parent for the control point may be specified, and FIG. 9B illustrates how the control point may be specified.

The window 900 of FIGS. 9A and 9B includes a first prompt 902 to choose a water source as the parent of the control point. Further, the window 900 of FIGS. 9A and 9B includes a second prompt 904 to choose a control point.

The first prompt 902 of FIG. 9A includes a drop-down menu 910a for choosing a water source. The drop-down menu 910a may include an input box 912a wherein a user may type in an identifier for a specific water source. Further, the drop-down menu 910a may include a first list 914a of water sources associated with the hydraulic system.

The second prompt 904 of FIG. 9B includes a drop-down menu 910b for choosing a control point. The drop-down menu 910b may include an input box 912b wherein a user may type in an identifier for a specific control point. Further, the drop-down menu 910b may include a second list 914b of control points associated with the hydraulic system.

Once the user specifies a parent water source and a child control point, associated diagrams are updated automatically to illustrate the selected control point as being coupled to the selected water source. For example, a hydraulic structure diagram (such as the hydraulic structure diagram 100 of FIG. 1) would illustrate the selected control point being positioned downstream of the selected water source. Further, the hydraulic structure diagram would illustrate the selected control point as being coupled to the selected water source via a pipe (where the pipe may be represented as a line, similar to the line 120 in FIG. 1). If the selected control point is a new control point (i.e., the selected control point is not currently represented in the hydraulic structure diagram), then the new control point would be represented in the hydraulic structure diagram as a new node positioned downstream of the selected water source, where a pipe (i.e., line) couples the new control point to the selected water source. Alternatively, if the selected control point is an existing control point (i.e., the selected control point is currently represented in the hydraulic structure diagram), then the selected control point would be represented in the hydraulic structure diagram as the same node, though the position of the node may change such that the node is positioned downstream of the selected water source.

According to one embodiment, when the selected control point is an existing control point, the previous parent-child relationship may continue to exist until the user specifies that it should be terminated. Specifically, the new parent-child relationship would be represented by a new pipe (i.e., new line) coupling the selected water source (i.e., the new parent node) to the selected control point (i.e., the child node). According to the embodiment, until a user indicates that the previous parent-child relationship should be terminated, the previous water source (i.e., the previous parent node) may continue to be located upstream from the selected control point and continue to have a pipe (i.e., existing line) coupling the previous water source (i.e., the previous parent node) to the selected control point.

According to an alternative embodiment, when the selected control point is an existing control point, the previous parent-child relationship may be terminated. Specifically, the new parent-child relationship would be represented by a new pipe (i.e., new line) coupling the selected water source (i.e., the new parent node) to the selected control point (i.e., the child node), and the previous parent-child relationship would cease to be represented. For example, the selected control point (i.e., the child node) would have no requirement to be located downstream from the previous water source (i.e., the previous parent) and the previous pipe (i.e., previous line) coupling the previous water source to the selected control point would be removed from the hydraulic structure diagram.

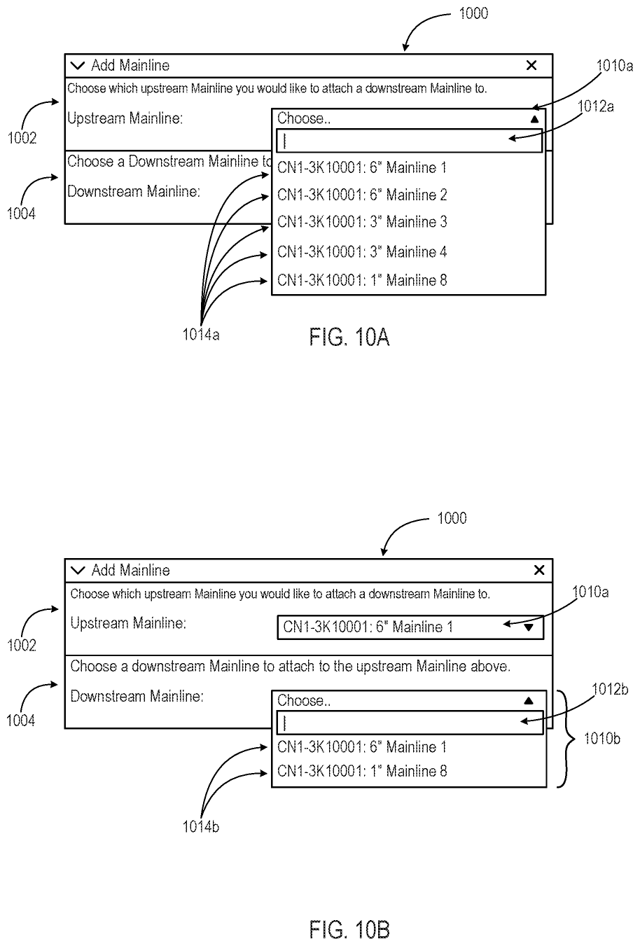

FIGS. 10A and 10B illustrate a window 1000 for adding a new or changing the arrangement of an existing mainline to a representation of a hydraulic system (such as to the hydraulic structure diagram 100 of FIG. 1), such that the mainline has a parent mainline. FIG. 10A illustrates how a parent mainline may be specified, and FIG. 10B illustrates how a child mainline may be specified.

The window 1000 of FIGS. 10A and 10B includes a first prompt 1002 to choose a parent mainline. Further, the window 1000 of FIGS. 10A and 10B includes a second prompt 1004 to choose a child mainline.

The first prompt 1002 of FIG. 10A includes a drop-down menu 1010a for choosing a parent mainline. The drop-down menu 1010a may include an input box 1012a wherein a user may type in an identifier for a specific parent mainline. Further, the drop-down menu 1010a may include a first list 1014a of potential parent mainlines associated with the hydraulic system.

The second prompt 1004 of FIG. 10B includes a drop-down menu 1010b for choosing a child mainline. The drop-down menu 1010b may include an input box 1012b wherein a user may type in an identifier for a specific child mainline. Further, the drop-down menu 1010b may include a second list 1014b of potential child mainlines associated with the hydraulic system.

Once the user specifies a parent mainline and a child mainline, associated diagrams are updated automatically to illustrate the selected child mainline as being coupled to the selected parent mainline. For example, a hydraulic structure diagram (such as the hydraulic structure diagram 100 of FIG. 1) would illustrate the selected child mainline as being positioned downstream of the selected parent mainline. Further, the hydraulic structure diagram would illustrate the selected child mainline as being coupled to the selected parent mainline via a pipe (where the pipe may be represented as a line, similar to the line 120 in FIG. 1). If the selected child mainline is a new mainline (i.e., the selected mainline is not currently represented in the hydraulic structure diagram), then the new mainline would be represented in the hydraulic structure diagram as a new node positioned downstream of the selected parent mainline, where a pipe (i.e., line) couples the new mainline to the selected parent mainline. Alternatively, if the selected child mainline is an existing mainline (i.e., the selected mainline is currently represented in the hydraulic structure diagram), then the selected mainline would be represented in the hydraulic structure diagram as the same node, though the position of the node may change such that the node is positioned downstream of the selected parent mainline.

According to one embodiment, when the selected child mainline is an existing mainline, the previous parent-child relationship may continue to exist until the user specifies that it should be terminated. Specifically, the new parent-child relationship would be represented by a new pipe (i.e., new line) coupling the selected parent mainline (i.e., the new parent node) to the selected child mainline (i.e., the child node). According to the embodiment, until a user indicates that the previous parent-child relationship should be terminated, the previous parent mainline (i.e., the previous parent node) may continue to be located upstream from the selected child mainline and continue to have a pipe (i.e., existing line) coupling the previous parent mainline (i.e., the previous parent node) to the selected child mainline.

According to an alternative embodiment, when the selected child mainline is an existing mainline, the previous parent-child relationship may be terminated. Specifically, the new parent-child relationship would be represented by a new pipe (i.e., new line) coupling the selected parent mainline (i.e., the new parent node) to the selected child mainline (i.e., the child node), and the previous parent-child relationship would cease to be represented. For example, the selected child mainline (i.e., the child node) would have no requirement to be located downstream from the previous parent mainline (i.e., the previous parent node) and the previous pipe (i.e., previous line) coupling the previous parent mainline to the selected child mainline would be removed from the hydraulic structure diagram.

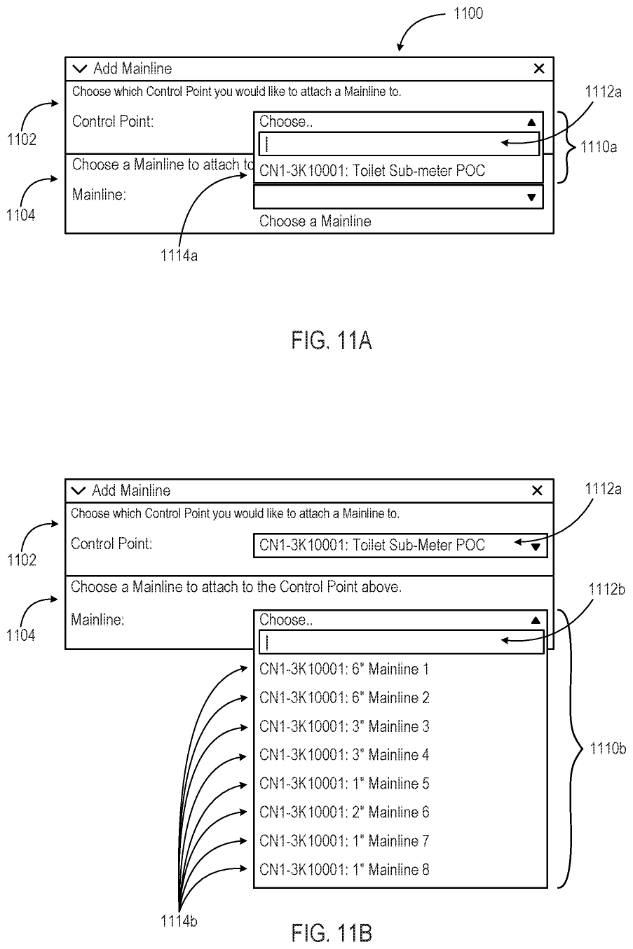

FIGS. 11A and 11B illustrate a window 1100 for adding a new or changing the arrangement of an existing mainline to a representation of a hydraulic system (such as to the hydraulic structure diagram 100 of FIG. 1) such that the mainline has a parent control point. FIG. 11A illustrates how a parent control point for the child mainline may be specified, and FIG. 11B illustrates how the child mainline may be specified.

The window 1100 of FIGS. 11A and 11B includes a first prompt 1102 to choose a control point as the parent of the mainline. Further, the window 1100 of FIGS. 11A and 11B includes a second prompt 1104 to choose a mainline as the child of the control point.

The first prompt 1102 of FIG. 11A includes a drop-down menu 1110a for choosing a parent control point. The drop-down menu 1110a may include an input box 1112a wherein a user may type in an identifier for a specific control point. Further, the drop-down menu 1110a may include a first list 1114a of control points associated with the hydraulic system.

The second prompt 1104 of FIG. 11B includes a drop-down menu 1110b for choosing a child mainline. The drop-down menu 1110b may include an input box 1112b wherein a user may type in an identifier for a specific mainline. Further, the drop-down menu 1110b may include a second list 1114b of mainlines associated with the hydraulic system.

Once the user specifies a parent control point and a child mainline, associated diagrams are updated automatically to illustrate the selected child mainline as being coupled to the selected parent control point. For example, a hydraulic structure diagram (such as the hydraulic structure diagram 100 of FIG. 1) would illustrate the selected child mainline as being positioned downstream of the selected parent control point. Further, the hydraulic structure diagram would illustrate the selected child mainline as being coupled to the selected parent control point via a pipe (where the pipe may be represented as a line, similar to the line 120 in FIG. 1). If the selected child mainline is a new mainline (i.e., the selected child mainline is not currently represented in the hydraulic structure diagram), then the new child mainline would be represented in the hydraulic structure diagram as a new node positioned downstream of the selected parent control point, where a pipe (i.e., line) couples the new child mainline to the selected parent control point. Alternatively, if the selected child mainline is an existing mainline (i.e., the selected child mainline is currently represented in the hydraulic structure diagram), then the selected child mainline would be represented in the hydraulic structure diagram as the same node, though the position of the node may change such that the node is positioned downstream of the selected parent control point.

According to one embodiment, when the selected child mainline is an existing mainline, the previous parent-child relationship may continue to exist until the user specifies that it should be terminated. Specifically, the new parent-child relationship would be represented by a new pipe (i.e., new line) coupling the selected parent control point (i.e., the new parent node) to the selected child mainline (i.e., the child node). According to the embodiment, until a user indicates that the previous parent-child relationship should be terminated, the previous parent control point (i.e., the previous parent node) may continue to be located upstream from the selected child mainline and continue to have a pipe (i.e., existing line) coupling the previous parent control point (i.e., the previous parent node) to the selected child mainline.

According to an alternative embodiment, when the selected child mainline is an existing mainline, the previous parent-child relationship may be terminated. Specifically, the new parent-child relationship would be represented by a new pipe (i.e., new line) coupling the selected parent control point (i.e., the new parent node) to the selected child mainline (i.e., the child node), and the previous parent-child relationship would cease to be represented. For example, the selected child mainline (i.e., the child node) would have no requirement to be located downstream from the previous parent control point (i.e., the previous parent node) and the previous pipe (i.e., previous line) coupling the previous parent control point to the selected child mainline would be removed from the hydraulic structure diagram.

Although specific rearrangements to a hydraulic structure diagram representation of a hydraulic system have been exemplified, other combinations are possible.

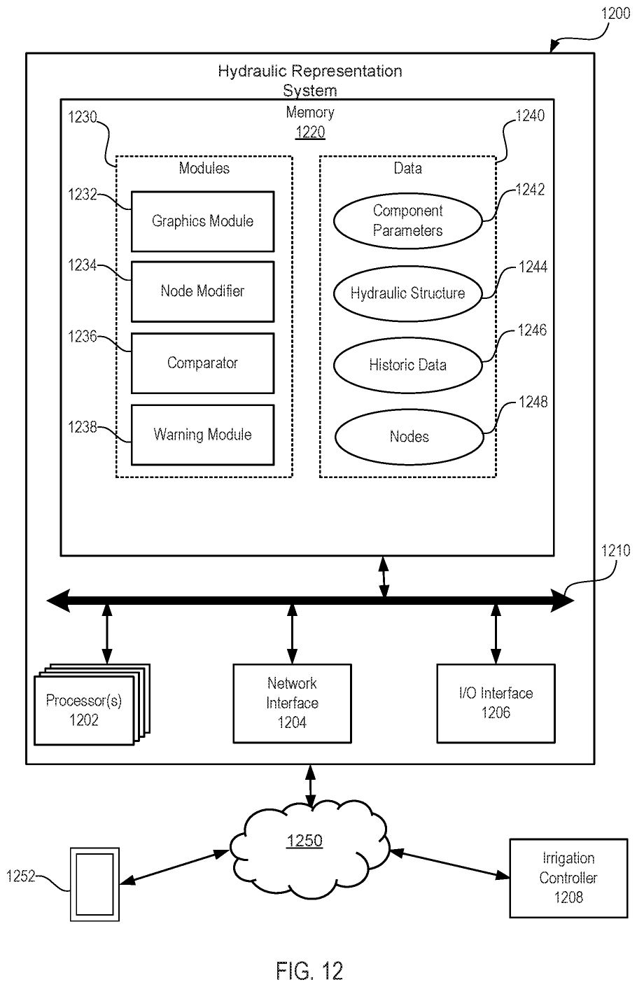

FIG. 12 illustrates a block diagram of a hydraulic representation system 1200 according to one embodiment. In various applications, the hydraulic representation system 1200 may be used to create and display hydraulic structure diagram representations of hydraulic systems (e.g., the hydraulic structure diagram 100 of FIG. 1) in an automated fashion.

The hydraulic representation system 1200 can include a memory 1220, one or more processors 1202, a network interface 1204, an input/output interface 1206, and a system bus 1210.

The one or more processors 1202 may include one or more general-purpose devices, such as an Intel®, AMD®, or other standard microprocessor. The one or more processors 1202 may include a special purpose processing device, such as ASIC, SoC, SiP, FPGA, PAL, PLA, FPLA, PLD, or other customized or programmable device. The one or more processors 1202 can perform distributed (e.g., parallel) processing to execute or otherwise implement functionalities of the presently disclosed embodiments. The one or more processors 1202 may run a standard operating system and perform standard operating system functions. It is recognized that any standard operating systems may be used, such as, for example, Microsoft® Windows®, Apple® MacOS®, Disk Operating System (DOS), UNIX, IRJX, Solaris, SunOS, FreeBSD, Linux®, ffiM® OS/2® operating systems, and so forth.

The memory 1220 may include static RAM, dynamic RAM, flash memory, one or more flip-flops, ROM, CD-ROM, DVD, disk, tape, or magnetic, optical, or other computer storage medium. The memory 1220 may include a plurality of program modules 1230 and program data 1240. The memory 1220 may be local to the hydraulic representation system 1200, as shown, or may be distributed and/or remote relative to the hydraulic representation system 1200.

The program modules 1230 may include all or portions of other elements of the hydraulic representation system 1200. The program modules 1230 may run multiple operations concurrently or in parallel by or on the one or more processors 1202. In some embodiments, portions of the disclosed modules, components, and/or facilities are embodied as executable instructions embodied in hardware or in firmware, or stored on a non-transitory, machine-readable storage medium. The instructions may comprise computer program code that, when executed by a processor and/or computing device, cause a computing system to implement certain processing steps, procedures, and/or operations, as disclosed herein. The modules, components, and/or facilities disclosed herein may be implemented and/or embodied as a driver, a library, an interface, an API, FPGA configuration data, firmware (e.g., stored on an EEPROM), and/or the like. In some embodiments, portions of the modules, components, and/or facilities disclosed herein are embodied as machine components, such as general and/or application-specific devices, including, but not limited to: circuits, integrated circuits, processing components, interface components, hardware controller(s), storage controller(s), programmable hardware, FPGAs, ASICs, and/or the like. Accordingly, the modules disclosed herein may be referred to as controllers, layers, services, engines, facilities, drivers, circuits, subsystems and/or the like.

The program modules 1230 may comprise a graphics module 1232, a node modifier module 1234, a comparator module 1236, and a warning module 1238. The graphics module 1232 may generate graphical displays of hydraulic system representations. In various embodiments, the graphics module 1232 generates hydraulic structure diagram representations of hydraulic systems (such as the hydraulic structure diagram 100 of FIG. 1). The graphics module 1232 may communicate with the input/output interface 1206 to display images to a user.

The node modifier module 1234 may communicate with the input/output interface 1206 to allow a user to modify the graphical representation of a hydraulic system. Specifically, the node modifier module 1234 may allow a user to add a new node to a hydraulic structure diagram representation of a hydraulic system (such as the hydraulic structure diagram 100 of FIG. 1). Alternatively, the node modifier module 1234 may allow a user to change parent-child relationships within a hydraulic structure diagram representation of a hydraulic system. Further, the node modifier module 1234 may allow a user to remove nodes from a hydraulic structure diagram representation of a hydraulic system. A user may also work with the node modifier module 1234 to specify which parameters to represent on a given node (e.g., pressure, flow rate).

The comparator module 1236 may determine whether parameters of certain components of a hydraulic system have surpassed certain thresholds. For example, the comparator module 1236 may receive a threshold for a flow rate for a specific component of a hydraulic system and also receive data from a flow meter within that component. If the data from the flow meter surpasses the flow rate threshold, the comparator module 1236 may throw a flag or store the information in a database. Further, the comparator module 1236 may pass information about broken thresholds to the warning module 1238. The thresholds may be user defined, based on manufacturer specifications, and/or based on historic data (e.g., pressure and flow rates). In some embodiments, the hydraulic representation system 1200 may adjust the thresholds based on a current status of another component. For example, a flow rate threshold at a line may be set to a first value when a control point upstream is open and set to a second value (e.g., zero) when the control point is closed.

The warning module 1238 may receive data from the comparator module 1236 when a threshold of a component of a hydraulic system has been surpassed or broken and thereafter send warnings to a user(s). The warning module 1238 may communicate with the graphics module 1232 to generate notifications on the display to the user(s). Alternatively, the warning module 1238 may send notifications to various external electronic devices via email, text, push notification, or other method. The warning module 1238 may generate specific messages to inform the user(s) as to which type of error the hydraulic system may be encountering. For example, if a specific component of the hydraulic system has an unscheduled flow, the warning module 1238 may notify the user(s) which component is having an unscheduled flow and give troubleshooting recommendations.

The memory 1220 may also include the program data 1240. Data generated by the hydraulic representation system 1200, such as by the program modules 1230 or other modules, may be stored on the memory 1220, for example, as stored program data 1240. The program data 1240 may be organized as one or more databases.

The program data 1240 may include component parameters 1242, hydraulic structure data 1244, historic data 1246, and node data 1248. The component parameters 1242 may include data to be displayed on nodes of a hydraulic structure diagram representation of a hydraulic system (such as the hydraulic structure diagram 100 of FIG. 1). For example, the component parameters 1242 may include component types, sensor readings, threshold data, and the like. The hydraulic structure data 1244 may include data for constructing a hydraulic structure diagram representation of a hydraulic system. The hydraulic structure data 1244 may comprise a list of nodes and information as to how nodes are to be interconnected (i.e., the hydraulic structure data 1244 may include parent-child relationships for each of the nodes of the hydraulic structure diagram). The historic data 1246 may include a history of sensor readings from various components of the hydraulic system. The historic data 1246 may include information for representing the sensor readings on a graph (such as time data). Further, the historic data 1246 may include a history of user modifications to a hydraulic structure diagram. The node data 1248 may include information to identify the component or component type of the hydraulic system that the node represents. Further, the node data 1248 may include parent-child relationships for specific nodes of the hydraulic structure diagram (i.e., hierarchal data such as upstream data and downstream data).

The input/output interface 1206 may facilitate user interaction with one or more input devices and/or one or more output devices. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, speaker, signal line, or other hardware with accompanying firmware and/or software. For example, in one embodiment, the input/output interface 1206 comprises a display to provide a GUI illustrating the hydraulic structure diagram representation of a hydraulic system. In some embodiments, the input/output interface 1206 is a touchscreen, and input is received via the touchscreen.

The network interface 1204 may facilitate communication with other computing devices and/or networks and/or other computing and/or communications networks. According to the figure, the network interface 1204 may communicate with a network 1250. The network interface 1204 may be equipped with conventional network connectivity, such as, for example, Ethernet (IEEE 802.3), Token Ring (IEEE 802.5), Fiber Distributed Datalink Interface (FDDI), or Asynchronous Transfer Mode (ATM). Further, the network interface 1204 may be configured to support a variety of network protocols such as, for example, Internet Protocol (IP), Transfer Control Protocol (TCP), Network File System over UDP/TCP, Server Message Block (SMB), Microsoft® Common Internet File System (CIFS), Hypertext Transfer Protocols (HTTP), Direct Access File System (DAFS), File Transfer Protocol (FTP), Real-Time Publish Subscribe (RTPS), Open Systems Interconnection (OSI) protocols, Simple Mail Transfer Protocol (SMTP), Secure Shell (SSH), Secure Socket Layer (SSL), and so forth.

The system bus 1210 may facilitate communication and/or interaction between the other components of the hydraulic representation system 1200, including the one or more processors 1202, the memory 1220, the input/output interface 1206, and the network interface 1204.

The network interface 1204 may allow the hydraulic representation system 1200 to communicate with the network1250 in order to transmit and receive information to and from one or more personal electronic devices (PEDs) 1252 and to and from an irrigation controller 1208 of a hydraulic system. The PED 1252 may be a smartphone, tablet, computer, smartwatch, or other electronic device whereon the network interface 1204 may send information that would allow a user to remotely view the hydraulic representation system 1200. The irrigation controller 1208 may be a controller that collects readings, status, and other information from sensors within the various components of the hydraulic system. Further, the irrigation controller 1208 may store tasks for the hydraulic system (such as switching commands for various valves and pumps of the hydraulic system). In some embodiments, a user may enter new components and associate the new component with upstream and downstream components using the PED 1252 or the irrigation controller 1208.

In one embodiment, the hydraulic representation system 1200 may allow a user to store and/or send commands to the irrigation controller 1208 to modify the operation of the hydraulic system.

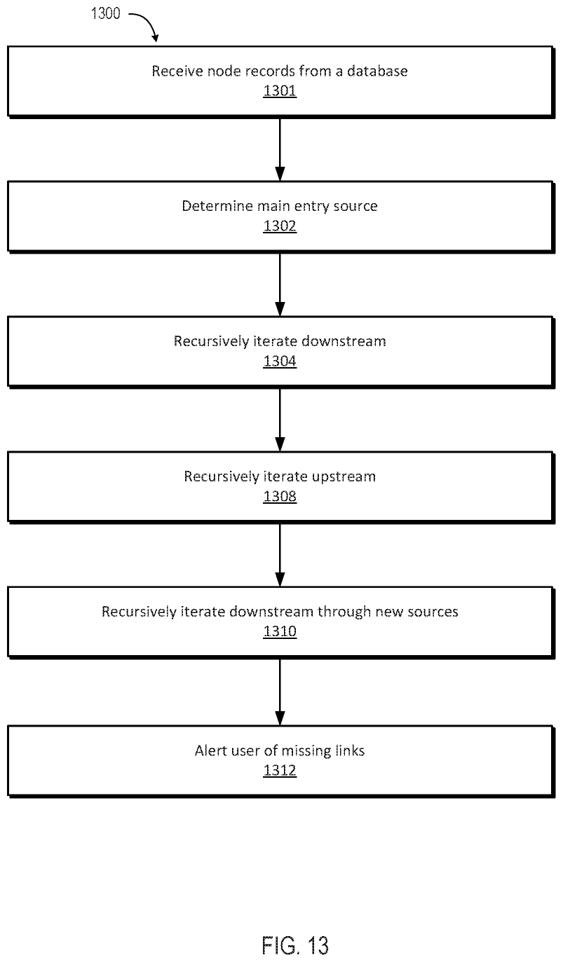

FIG. 13 is a method 1300 for generating a display of a hydraulic structure diagram representation of a hydraulic system (similar to the hydraulic structure diagram 100 of FIG. 1). According to various applications, the method 1300 may be employed anytime the hydraulic structure diagram representation is opened, restarted, and/or refreshed.

The method 1300 may retrieve information about a hydraulic structure diagram from a database, wherein the data comprises node information and parent-child relationships for the nodes. The method 1300 may initiate by receiving 1301 node records from a database. The node record comprising data associated with a component (component record), and the structure (e.g., hierarchal data such as upstream data, and downstream data) of the node to be rendered. The method 1300 further determines 1302 a main entry source. In various embodiments, an entry source may be a water source (such as the water source 110a of the hydraulic structure diagram 100 of FIG. 1). The method 1300 may then perform the step of recursively iterating 1304 downstream starting at the main entry source node, where within each iteration, the method 1300 may include gathering information about the node and moving on to the next child node. If a specific path of the hydraulic structure diagram has no more child nodes, the method 1300 may include returning to the nearest parent node and iterating through the other branches from that parent. Once the method 1300 has recursively iterated 1304 downstream, the method 1300 may perform the step of recursively iterating upstream 1308 from the last child node to determine whether other entry points (e.g., other water sources) are present. The method 1300 may then perform the step of recursively iterating 1310 downstream through the new sources. The method 1300 further includes alerting 1312 the user(s) of any missing links in the hydraulic structure diagram. The method 1300 may further include displaying the hydraulic structure for a user via a GUI.

A missing link may be determined if the method 1300 reaches the top of a branch and the top node is not a water source. Alternatively, a missing link may be determined if the method 1300 finishes generating the display for the hydraulic structure diagram and one or more nodes still exist in the original node database that have not been represented in the hydraulic structure diagram. Further, a missing link may be determined if the method 1300 finishes generating the display for the hydraulic structure diagram and one or more nodes are not connected to anything. In various embodiments, the method 1300 may also include the step of identifying each missing link (where information about the missing link is saved) and sending an alert to the user(s) that one or more links are missing.

### EXAMPLE EMBODIMENTS

The following are some example embodiments within the scope of the disclosure. In order to avoid complexity in providing the disclosure, not all of the examples listed below are separately and explicitly disclosed as having been contemplated herein as combinable with all of the others of the examples listed below and other embodiments disclosed hereinabove. Unless one of ordinary skill in the art would understand that these examples listed below (and the above disclosed embodiments) are not combinable, it is contemplated within the scope of the disclosure that such examples and embodiments are combinable.

Example 1. A real-time hydraulic representation system comprising: a memory to store component records of a hydraulic system; and one or more processing units to: receive a component record comprising a hydraulic component type; receive upstream data and downstream data associated with the component record; generate a node record comprising the component record, the upstream data, and the downstream data; and render a hydraulic structure diagram illustrating a node representing the node record in relation to a plurality of other nodes representing the stored component records based on the component record, the upstream data, and the downstream data.

Example 2. The hydraulic representation system of claim 1, wherein the one or more processing units are further to determine a depth and a position of the node.

Example 3. The hydraulic representation system of claim 2, wherein the node further comprises the depth, the position, and associated pipes between the node and any other node.

Example 4. The hydraulic representation system of claim 2, wherein the one or more processing units are to receive user input selecting the node and generate a detailed component window displaying detailed information about the node based on the received user input.

Example 5. The hydraulic representation system of claim 4, wherein the one or more processing units are to ensure that the node is visible with the detailed component window displayed by shifting the hydraulic structure diagram based on the depth and position of the node.

Example 6. The hydraulic representation system of claim 4, wherein the detailed component window comprises an error message.

Example 7. The hydraulic representation system of claim 6, wherein the error message comprises troubleshooting instructions.

Example 8. The hydraulic representation system of claim 1, wherein the one or more processing units are further to generate an alert if a component of the hydraulic system malfunctions.

Example 9. The hydraulic representation system of claim 1, wherein the one or more processing units are further to receive information from the hydraulic system regarding a current status of one or more components, and cause the hydraulic structure diagram to illustrate a flow of water.

Example 10. The hydraulic representation system of claim 1, wherein the one or more processing units receive the component record, upstream data, and downstream data from an irrigation controller.

Example 11. The hydraulic representation system of claim 1, wherein the one or more processing units receive the component record, upstream data, and downstream data from a personal electronic device.

Example 12. The hydraulic representation system of claim 1, wherein the one or more processing units are further to send the hydraulic structure diagram to a personal electronic device for display.

Example 13. The hydraulic representation system of claim 1, wherein the hydraulic structure diagram comprises real-time sensor information from components of the hydraulic system.

Example 14. The hydraulic representation system of claim 13, wherein the real-time sensor information comprises pressure and water flow.

Example 15. A method to illustrate a hydraulic structure diagram representative of a hydraulic system, the method comprising: determining a water source node from a plurality of nodes, each node comprising a component type, upstream data, and downstream data; recursively iterating downstream from the water source node based on the downstream data; recursively iterating upstream from the downstream nodes discovered based on the upstream data; and if additional water source nodes are discovered while recursively iterating upstream, recursively iterating downstream from the additional water source nodes based on the downstream data.

Example 16. The method of claim 15, further comprising identifying missing links by determining if each node of the plurality of nodes is downstream from at least one water source node.

Example 17. The method of claim 16, further comprising alerting a user of missing links.

Example 18. A hydraulic representation system comprising: a memory to store component data of a hydraulic system; and a processor to: receive a component data comprising a hydraulic component type; receive an upstream data and a downstream data associated with the component data; generate a node comprising the component data, the upstream data, and the downstream data; receive a sensor reading from a component corresponding to the component data; and generate a hydraulic structure diagram illustrating the node in relation to a plurality of other nodes based on the hydraulic component type, the upstream component, and the downstream component, wherein the node displays the sensor reading from the component.

Example 19. The hydraulic representation system of claim 18, wherein the processor is further to: monitor sensor data from a component associated with the component data; and generate an alert if the sensor data exceeds a threshold.

Example 20. The hydraulic representation system of claim 19, wherein the threshold is based on historic sensor data.

Example 21. A non-transitory computer-readable storage medium having computer-readable instructions stored thereon, the computer readable instructions configured to, when executed by a processor, cause the processor to perform operations including: receiving a component data comprising a hydraulic component type; receiving an upstream data and a downstream data associated with the component data; generating a node comprising the component data, the upstream data, and the downstream data; receiving a sensor reading from a component corresponding to the component data; and generating a hydraulic structure diagram illustrating the node in relation to a plurality of other nodes based on the hydraulic component type, the upstream component, and the downstream component, wherein the node displays the sensor reading from the component.

Example 22. The non-transitory computer-readable storage medium of claim 21, wherein the computer-readable instructions are further configured to, when executed by a processor, cause the processor to perform operations including: monitoring sensor data from a component associated with the component data; and generating an alert if the sensor data exceeds a threshold.

Example 23. The non-transitory computer-readable storage medium of claim 22, wherein the threshold is based on historic sensor data.

This disclosure has been made with reference to various embodiments, including the best mode. However, those skilled in the art will recognize that changes and modifications may be made to the embodiments without departing from the scope of the present disclosure. While the principles of this disclosure have been shown in various embodiments, many modifications of structure, arrangements, proportions, elements, materials, and components may be adapted for a specific environment and/or operating requirements without departing from the principles and scope of this disclosure. These and other changes or modifications are intended to be included within the scope of the present disclosure.

This disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element. The scope of the present invention should, therefore, be determined by the claims.

1. A real-time hydraulic representation system comprising:
a memory to store component records of a hydraulic system; and
one or more processing units to:
receive a component record comprising a hydraulic component type;
receive upstream data and downstream data associated with the component record;
generate a node record comprising the component record, the upstream data, and the downstream data; and
render a hydraulic structure diagram illustrating a node representing the node record in relation to a plurality of other nodes representing the stored component records based on the component record, the upstream data, and the downstream data.

2. The hydraulic representation system of claim 1, wherein the one or more processing units are further to determine a depth and a position of the node.

3. The hydraulic representation system of claim 2, wherein the node further comprises the depth, the position, and associated pipes between the node and any other node.

4. The hydraulic representation system of claim 2, wherein the one or more processing units are to receive user input selecting the node and generate a detailed component window displaying detailed information about the node based on the received user input.

5. The hydraulic representation system of claim 4, wherein the one or more processing units are to ensure that the node is visible with the detailed component window displayed by shifting the hydraulic structure diagram based on the depth and position of the node.

6. The hydraulic representation system of claim 4, wherein the detailed component window comprises an error message.

7. The hydraulic representation system of claim 6, wherein the error message comprises troubleshooting instructions.

8. The hydraulic representation system of claim 1, wherein the one or more processing units are further to generate an alert if a component of the hydraulic system malfunctions.

9. The hydraulic representation system of claim 1, wherein the one or more processing units are further to receive information from the hydraulic system regarding a current status of one or more components, and cause the hydraulic structure diagram to illustrate a flow of water.

10. The hydraulic representation system of claim 1, wherein the one or more processing units receive the component record, upstream data, and downstream data from an irrigation controller.

11. The hydraulic representation system of claim 1, wherein the one or more processing units receive the component record, upstream data, and downstream data from a personal electronic device.

12. The hydraulic representation system of claim 1, wherein the one or more processing units are further to send the hydraulic structure diagram to a personal electronic device for display.

13. The hydraulic representation system of claim 1, wherein the hydraulic structure diagram comprises real-time sensor information from components of the hydraulic system.

14. The hydraulic representation system of claim 13, wherein the real-time sensor information comprises pressure and water flow.

15. A method to illustrate a hydraulic structure diagram representative of a hydraulic system, the method comprising:
determining a water source node from a plurality of nodes, each node comprising a component type, upstream data, and downstream data;
recursively iterating downstream from the water source node based on the downstream data;
recursively iterating upstream from the downstream nodes discovered based on the upstream data; and
if additional water source nodes are discovered while recursively iterating upstream, recursively iterating downstream from the additional water source nodes based on the downstream data.

16. The method of claim 15, further comprising identifying missing links by determining if each node of the plurality of nodes is downstream from at least one water source node.

17. The method of claim 16, further comprising alerting a user of missing links.

18. A hydraulic representation system comprising:
a memory to store component data of a hydraulic system; and
a processor to:
receive a component data comprising a hydraulic component type;
receive an upstream data and a downstream data associated with the component data;
generate a node comprising the component data, the upstream data, and the downstream data;
receive a sensor reading from a component corresponding to the component data; and
generate a hydraulic structure diagram illustrating the node in relation to a plurality of other nodes based on the hydraulic component type, the upstream component, and the downstream component, wherein the node displays the sensor reading from the component.

19. The hydraulic representation system of claim 18, wherein the processor is further to:
monitor sensor data from a component associated with the component data; and
generate an alert if the sensor data exceeds a threshold.

20. The hydraulic representation system of claim 19, wherein the threshold is based on historic sensor data.
